(19) United States
(12) Patent Application Publication
(10) Pub. No.: US 2006/0108771 A1
(43) Pub. Date: May 25, 2006

(54) Easy alignment apparatus for a vehicle and trailer

(76) Inventors: Mike Elkins, Barnhart, TX (US); Mark Elkins, San Angelo, TX (US); Chad Elkins, San Angelo, TX (US)

Correspondence Address: Mr. Mike Elkins, PO BOX 185, Barnhart, TX, 76930, US

(21) Appl. No.: 10/992,534

(22) Filed: Nov. 19, 2004

(51) Int. Cl. B60D 1/36

(52) U.S. Cl. 280/477

(57) ABSTRACT

A device designed to facilitate and permit the precise and easy alignment of a vehicle and a trailer. The invention relates to the field of trailer hitch guide mechanisms and more specifically, pertains to a new trailer hitch guide apparatus to aid the operator of a vehicle in attaining the proper alignment of a vehicle's tow hitch to a trailer hitch coupler regardless of trailer function, size or design. Such coupling is achieved through the use of a position indicator, that may be mounted on said vehicle or trailer, and a guidance marker, which may also be mounted to either vehicle or trailer. As such the invention is functional utilizing a variety of vehicles and trailer configurations.

### BACKGROUND OF THE INVENTION

1. Field of the Invention

The present invention relates to the field of trailer hitch guide mechanisms and more specifically, pertains to a new trailer hitch guide apparatus to aid the operator of a vehicle in attaining the proper alignment of a vehicle's tow hitch to a trailer hitch coupler regardless of trailer function, size or design.

2. Description of the Prior Art

The use of trailer hitch mechanisms has been well known for many years. There have been many improvements and mechanisms designed specifically to guide a vehicle operator to the proper location for the coupling of a trailer with a vehicle through a trailer hitch. The problems with aligning utility trailers, horse trailers, gooseneck trailers and even fifth wheel trailers are well known. If is for that reason that many attempts have been made in efforts to facilitate this procedure. The prior art devices and methods outlined below have numerous drawbacks. Mainly, the drawbacks of the prior art are in relation to installation and adaptability. The prior art, for the most part, requires a pair of indicating masts that must be aligned with each other. These masts are often connected to the vehicle and trailer in such as a manner as to require a lengthy installation and in times replacement of components in their entirety. Additionally, the existing devices are flawed in the fact that they are not adaptable to a variety of vehicles or trailers. It is common for some vehicles to now utilize two or more ball hitches of varying sizes for different load requirements. The existing designs are impractical when dealing with this situation or when a vehicle that is not properly equipped is used. and are as follows:

Additionally, improvements to towing vehicles have rendered some of the prior art designs needless and in some cases impractical or impossible. An example of this would be the existing backup light often located at the rear of current pickup trucks. The existence of a backup light removes the need for lighted position indicators, as a simple reflective surface would be sufficient in dim light or nighttime use and would not require an additional power supply. There has also been a growing interest in sports utility vehicles (SUVs). These vehicles are often equipped with a rear-mounted spare tire. Many of the existing designs are incompatible with these SUVs, as the indicators can be hidden by the spare tire, or as they may be unable to be installed correctly with an existing rear-mounted spare tire and tire bracket.

Also found in the prior art are several methods and devices to aid a vehicle operator when guiding a vehicle toward a trailer which rely on non-visual guidance systems. These methods and devices require the use of radio waves, RFI transceivers, laser sensors or live video feeds directly into the operator cab. Through these devices and methods may be effective, they are, by design, difficult or expensive to produce. Additionally, these systems would require additional power consumption, and in some cases, a secondary power source. Finally, these high-tech methods and devices are most likely not easily transferable to other vehicles or trailers and are of such detailed construction that they are not easily repaired or serviced should the need arise. As such, there has been a long felt but unsolved need for an improved and simple trailer coupling invention while minimizing or eliminating modifications required for the trailer. Those of skill in the art will greatly appreciate the present invention which addresses the above problems and other problems.

### SUMMARY OF THE INVENTION

It is, therefore, an objective of the present invention to provide an improved system for visually indicating a proper alignment between a trailer and vehicle.

Another objective is to provide an improved system for visually indicating proper vehicle/trailer alignment that will require only minor modifications to a trailer.

Another objective is to provide an improved system for visually indicating proper vehicle/trailer alignment that is easy to install and use with no special training or skill required.

Another objective is to provide an improved system for visually indicating proper vehicle/trailer alignment that is adjustable to accommodate a variety of vehicle sizes and designs.

Another objective is to provide an improved system for visually indicating proper vehicle/trailer alignment that is compatible with sports utility vehicles.

Another objective is to provide an improved system for visually indicating proper vehicle/trailer alignment that is compatible with vehicles utilizing two or more ball hitches of different sizes or design.

Another objective is to provide an improved system for visually indicating proper vehicle/trailer alignment that can be adapted for use with irregular or oversized trailers, such as horse trailers or modified trailers.

Another objective is to provide an improved system for visually indicating proper vehicle/trailer alignment that is compatible with gooseneck trailers.

Another objective is to provide an improved system for visually indicating proper vehicle/trailer alignment that may be readily used with a fifth wheel trailer.

Another objective is to provide an improved system for visually indicating proper vehicle/trailer alignment that can be readily adaptable with a variety of indicator caps for various environments or requirements.

These and other objectives, features, and advantages of the present invention will become apparent from the drawings, the following descriptions, and the appended claims.

It is understood, however, that any listed objective and/or other objectives, features, and advantages of the invention are provided only as an aid in understanding aspects of the invention, and are not intended to limit the invention in any way, and therefore do not form a comprehensive or restrictive list of objectives, and/or features, and/or advantages of the invention.

### BRIEF SUMMARY OF THE ILLUSTRATIONS

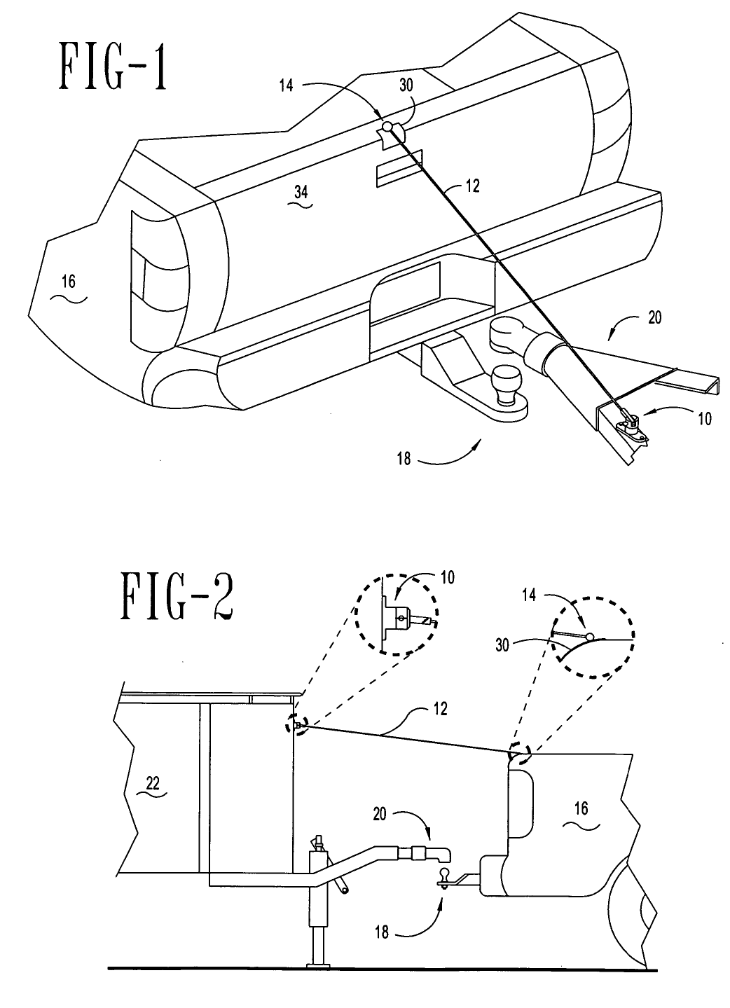

FIG. 1 is an elevated perspective view in which a standard utility trailer has a visual alignment system mounted upon its frame and configured as to indicate when a pickup truck is in the proper position to be coupled with said trailer. The indicating system is illustrated as comprising of a base unit that is mounted to the trailer, a pivotal section that may be rotated 360 degrees, an adjustable rod support that is adjustable in angle, an extension rod, and a position marker.

Said base section is bolted or similarly attached to the frame of the trailer at a location determined by the operator. A proper location can be achieved by trimming or otherwise shortening the extension rod to a desired size or by positioning the base section in a convenient location on said trailer relative to the untrimmed extension rod. The position marker is shown attached to the end of the extension rod opposite the adjustable rod support. An adequately sized strip of fluorescent tape or similar marker is shown attached to the center of a pickup truck tailgate. This guidance marker will be used to indicate that the hitch and the tongue are properly aligned.

FIG. 2 is a side elevation with portions removed in which the an unconventional trailer has the indicator base mounted to the uppermost portion of the trailer's outer wall. Said indicator base is bolted or similarly attached to the frame of the trailer after the operator has determined the distance where the swivel guide should be bolted. An adequately sized strip of fluorescent tape or similar marker is shown attached to the center of a pickup truck tailgate. This guidance marker will be used to indicate that the hitch and the tongue are properly aligned.

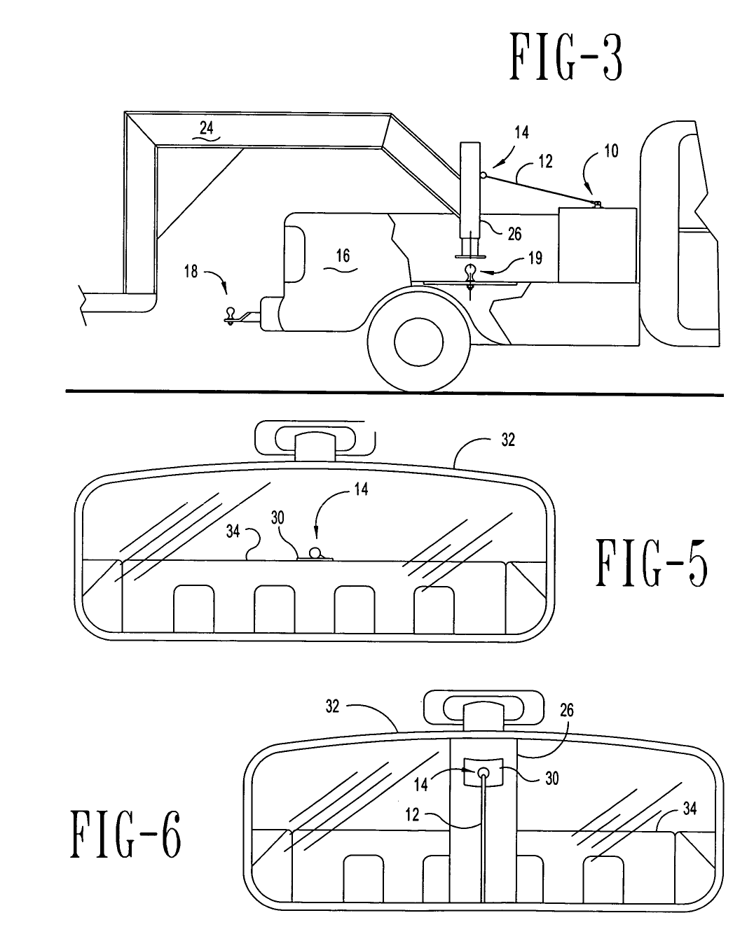

FIG. 3 is a side elevation with portions removed in which the indicator base is mounted atop a pickup truck. In this configuration, a gooseneck trailer is illustrated in proper position for coupling with the pickup truck. A position marker is illustrated as being in contact with the coupler of said trailer.

FIG. 4 is an aerial view with portions removed illustrating the vehicle operator located inside the cab. By using the vehicle's rear view mirror, said operator is able to visually confirm the proper location of the vehicle in relation to the trailer by means of a position indicator and a guidance marker. Said guidance indicator and position marker are shown to be in proper alignment for coupling the trailer to said vehicle.

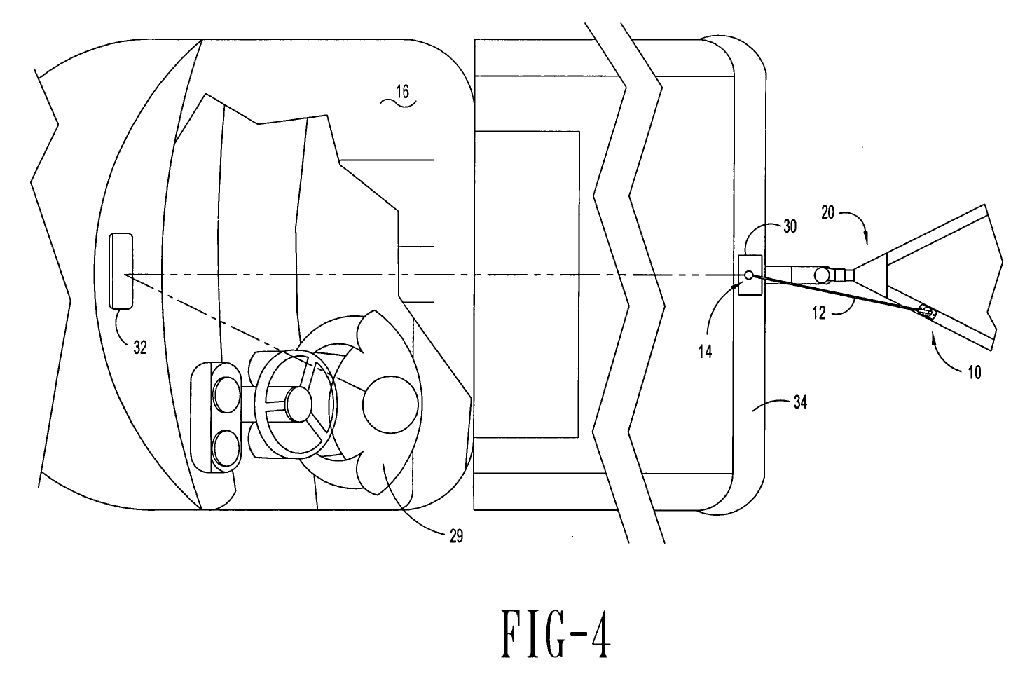

FIG. 5 is a partial view of a vehicle rear-view mirror as seen by the vehicle operator and illustrates the proper use of the visual alignment system whereas the position indicator indicates a proper alignment with a trailer by being in alignment with a guidance marker located on the vehicle tailgate.

FIG. 6 is a partial view of a vehicle rear-view mirror as seen by the vehicle operator and illustrates the proper use of the visual alignment system to position a gooseneck trailer whereas the position indicator indicates a proper alignment between the gooseneck trailer and vehicle hitch by being in alignment with a guidance marker located on the gooseneck coupler.

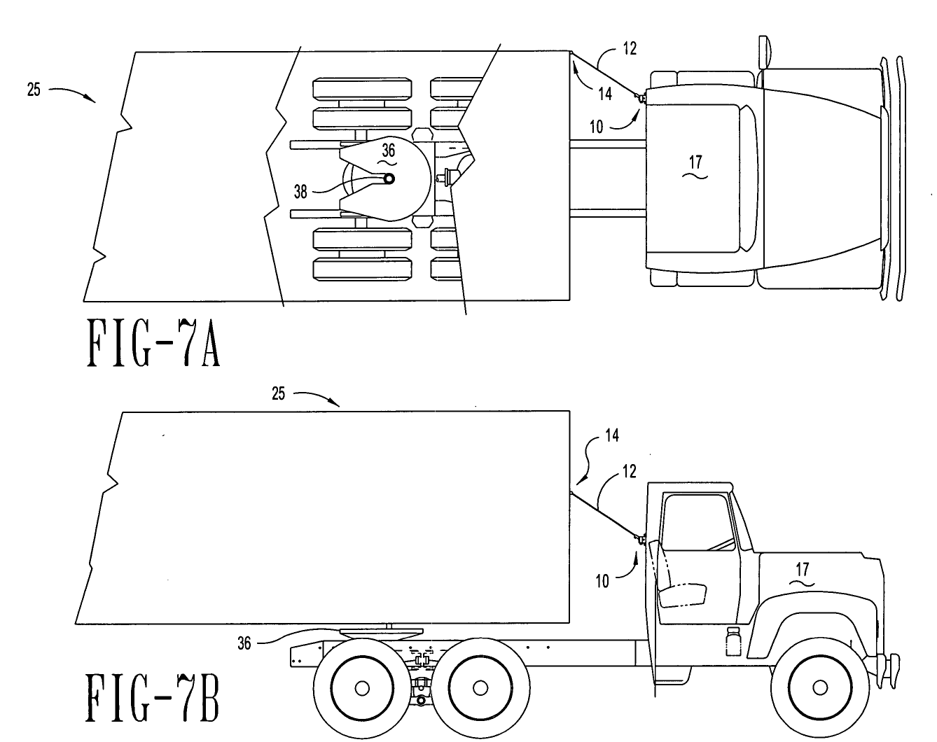

FIG. 7A is an aerial view with portions removed of a fifth wheel tractor and trailer utilizing the visual alignment system. The position indicator and guidance marker visually indicate the vehicle's position and distance to the fifth wheel trailer necessary for proper alignment.

FIG. 7B is an side elevation view with portions removed of a fifth wheel tractor and trailer utilizing the visual alignment system. The position indicator and guidance marker visually indicate the vehicle's position and distance to the fifth wheel trailer necessary for proper alignment.

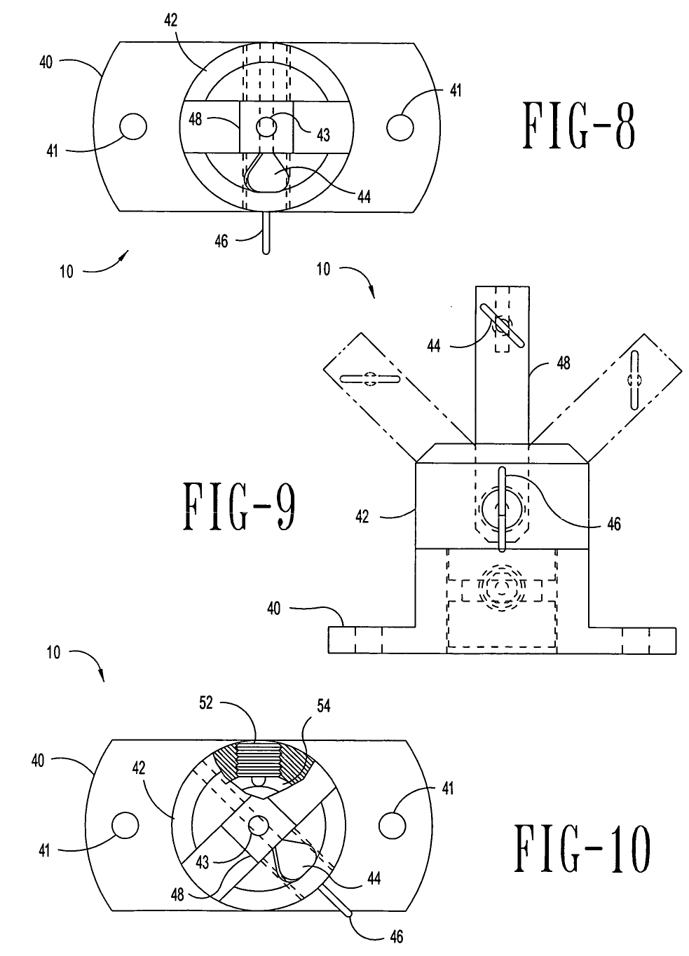

FIG. 8 is a top view of the visual alignment system. Said base unit is illustrated without an extension rod or position indicator attached.

FIG. 9 is a side elevation of the visual alignment system. Said base unit is illustrated without an extension rod or position indicator attached. The individual components of said base unit are illustrated and include a base unit that is mounted to a trailer or vehicle, a pivotal section that may be rotated 360 degrees, an adjustable rod support that may be angled as required by the operator.

FIG. 10 is a top view of the visual alignment system with portions removed that illustrates a set screw intended to be tightened against an interlocking pivot section as to lock the upper pivotal section in place.

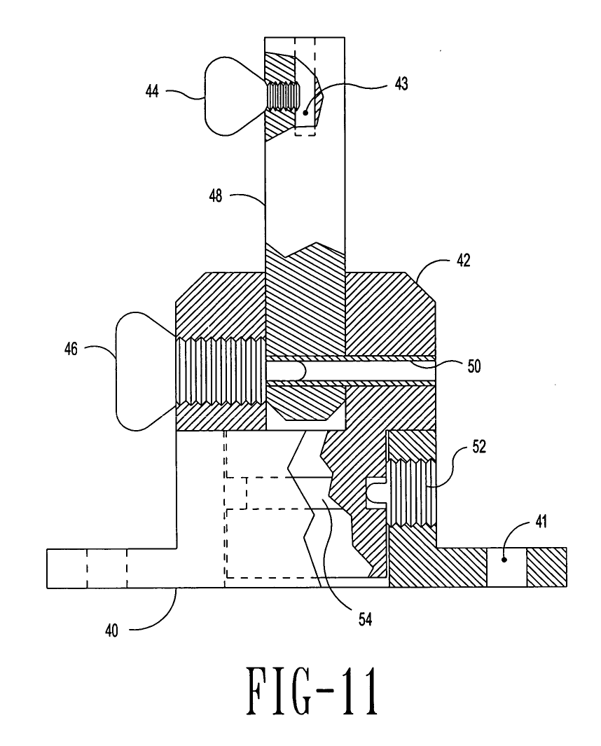

FIG. 11 is a side elevation of the visual alignment system with portions removed, and illustrates the individual components of the invention without an extension rod or position indicator attached. A base section is illustrates as containing two apertures for use with mounting bolts or similar. The base section also includes a large aperture located near the center of said base section. A pivotal section containing an interlocking pivot section introduced into the base section aperture as to interlock the two sections. The base and pivotal sections are secured in place by a set screw that may be loosened or tightened as to allow or prohibit the rotation of the pivotal section. Said pivotal section contains a recess of sufficient size as to allow a rod support member to be introduced therein. Said rod support contains a recess, cylindrical in shape of sufficient size and depth as to allow the extension rod to fit within and be secured in location with the use of an adjustment screw that may by tightened or loosened by hand as to allow or prohibit the insertion and removal of said extension rod. Said rod support also contains an aperture located opposite said recess of size and design as to align with an aperture found the pivotal section. A hollow pin is inserted through the aligned apertures of said pivotal section and said rod support in such a manner as to bind the two components. A secondary adjustment screw that may be manually tightened or loosened as to compress or release said rod support against the recess of the pivotal section as to allow or restrict the pivotal movement of said rod support around said hollow pin.

FIG. 12 is a side elevation of the invention with portions removed as to further illustrate the relationship between the base unit, extension rod and position indicator. Further, the illustration indicated the position indicator as consisting of a cap of such construction and design as to fit tightly on the extension rod and a larger outer wall as to provide a highly visible position indicator.

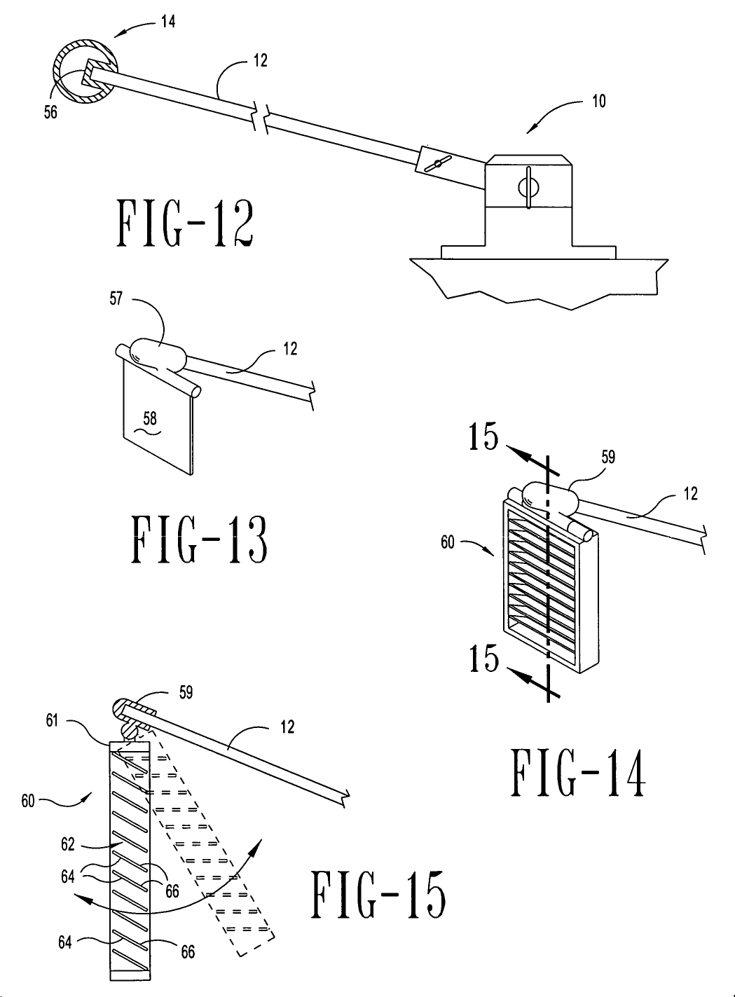

FIG. 13 is a side perspective view of the invention with portions removed which illustrates a possible alternative visual position indicator comprised of a cap of such construction and design as to fit tightly on the extension rod and a flat flag-like indicator of such construction and design as to provide a large and highly visible position indicator that may flex or pivot when contacting a vehicle or trailer component.

FIG. 14 is a side perspective view of the invention with portions removed which illustrates a possible alternative visual position indicator comprised of a cap of such construction and design as to fit tightly on the extension rod and a specialized indicator of such construction and design as to provide a large and highly visible position indicator in dim light or darkness that will pivot when contacting a vehicle or trailer component.

FIG. 15 is a side elevation sectional view of the invention taken about line 15-15 in FIG. 14, illustrating an alternative visual position indicator comprised of a cap of such construction and design as to fit tightly on the extension rod and a specialized indicator of such construction and design as to provide a large and highly visible position indicator in dim light or darkness that will pivot when contacting a vehicle or trailer component and comprising of a frame and a plurality of angled fins of such design and construction as to have a reflective face and a non-reflective opposite face. Said fins are positioned within said frame in an angled fashion as to provide a highly reflective surface when aligned in a generally vertical position. When pivoted by contacting a vehicle or trailer component, said fins will pivot with the frame, gradually diminishing the amount of reflected light, generally provided by a vehicle back-up light, until the indicator can not be easily seen in low light or darkness.

### DETAILED DESCRIPTION OF THE PREFERRED EMBODIMENT

Referring now to the drawings wherein the illustrations are for the purposes of illustrating the preferred embodiments of this invention only and not for the purposes of limiting same, FIG. 1 illustrates an innovative and improved system for visually indicating a proper alignment between a trailer and vehicle required for easy coupling of said truck and trailer. The pickup truck 16 is equipped with a guidance marker 30 generally located upon the pickup tailgate 34. Said guidance marker 30 is generally of a construction and design similar to a reflective tape or sticker as to provide a highly visible point of reference to the location of the truck ball hitch 18. A visible guidance system is mounted onto a trailer and is consisted of three portions; a base unit 10, an extension rod 12, and a visible position marker 14. Said guidance system is configured and adjusted on installation as to provide a reference point on the truck to indicate a proper alignment between the trailer coupler 20 and the truck hitch 18. Once said reference point has been determined by the vehicle operator, the guidance marker is applied to the truck 16, preferably on the tailgate section 34. When installed correctly as illustrated in FIG. 1, the vehicle operator will be able to successfully maneuver the truck 16 into proper alignment with the trailer by steering the guidance marker 30 towards the visible position marker 14.

With reference now to FIG. 2, the invention is illustrated in an alternative installation whereas the base unit 10 is mounted onto the wall of an enclosed trailer 22. In a similar fashion, the truck 16 is maneuvered toward the trailer 22 until the position indicator 14 is satisfactorily located above the guidance marker 30. Once the indicator 14 and marker 30 are aligned, the trailer coupler 20 and the truck hitch 18 are properly aligned for easy coupling of said truck 16 and trailer 22.

Referring now to FIG. 3, the invention is illustrated in the preferred configuration for the visual guidance needed to couple a gooseneck trailer 24. The vehicle operator maneuvers the truck 16 toward the gooseneck trailer 24. The visual guidance device is shown with the base unit 10 mounted to said pickup truck 16. The extension member 12 is shown leading from the base unit 10 generally towards the rear of the truck and with the position indicator 14 in contact with the gooseneck trailer coupler 26. Using proper guidance and visually confirming contact between said coupler 26 and the position indicator 14, the gooseneck trailer 24 may be coupled to the truck 16 by means of a gooseneck hitch 19.

Referring now to FIG. 4, the invention is illustrated from an aerial view and is shown relevant to the line of sight of the vehicle operator 29. As is illustrated in the FIG, the vehicle operator 29 can clearly confirm the proper alignment of the position indicator 14 and the guidance marker 30.

In reference to FIG. 5, the invention is illustrated from the point of view of the vehicle operator, as it would be seen through a vehicle rear-view mirror 32. From the view illustrated, the rear of the vehicle is visible, with the guidance marker 30 clearly visible on the tailgate 34 portion of the vehicle. The position indicator 14 can clearly be seen resting atop the guidance marker.

Referring to FIG. 6, the invention is illustrated from the point of view of the vehicle operator, as it would be seen through a vehicle rear-view mirror 32 when coupling a vehicle to a gooseneck trailer. From the view illustrated, the rear of the vehicle is visible along with the gooseneck coupler 26. In the configuration illustrated in the FIG, the extension rod 12 is shown pointing away from the vehicle and towards the gooseneck trailer. Through proper maneuvering, the vehicle operator can align the position indicator 14 with a guidance marker 30 located on the exterior of the gooseneck trailer coupler 26. Contact between said marker 30 and the position indicator 14.

Referring now to FIGS. 7A and 7B, the invention is illustrated in relation to its use with a fifth wheel truck 17 and trailer 25 configuration. By mounting the apparatus base unit 10 to the rear of the truck 17 cab, the extension rod 12 and position indicator 14 properly indicate the cab position in relation to the trailer 25. By utilizing the invention, a fifth wheel truck operator may successfully steer the cab towards the trailer 25 in a manner as to more easily connect the truck fifth wheel hitch 36 to the trailer kingpin 38.

Referring to FIGS. 8, 9, 10 and 11, the base unit portion 10 of the invention is critical to the versatility of the invention. Said base unit 10 is comprised of three major components; a base or mounting section 40, a pivotal section 42 and an adjustable rod support 48. Additionally, these components are secured in place and designed to work with a plurality of adjustment screws 44 and 46, being of such design as to be easily tightened and loosened by hand with only average effort and no special tools, a set screw 52 and a hollow pivot pin 50.

Said base section 40 is comprised of a solid construction and contains a large central aperture and two minor apertures 41 intended to be used to bolt the base section to an existing trailer or vehicle. The pivotal section 42 is designed in a manner as to fit within the large aperture of the base section 40. Upon the introduction of the pivotal section 43 into the base section 40, an interlocking portion 54, which is grooved about its circumference is locked within the base section 40 through the use of a set screw 52 having a formed nipple of such design as to fit within the groove of said interlocking portion 54. When the set screw 52 is loosened, the pivotal section 42 is free to pivot within said base structure 40. The set screw 52 may be tightened, thereby applying pressure to the interlocking portion 54 of the pivotal section 42 and locking the same.

Said rod support 48 contains a recessed portion 43 located at one end and an aperture located near the opposite end of said rod support 48. Said aperture is of a design and construction as to correlate to a corresponding aperture within the pivotal section 42. Upon inserting said rod support 48 into the pivotal section 42 by means of a recessed section within the same, a hollow pivot pin 50 is inserted through both the pivotal section 42 and said rod support 48. An adjustment screw 46 is introduced into the pivotal section 40 opposite the pivot pin 50 in such a manner as to apply pressure to the rod support 48 upon tightening. When the adjustment screw 46 is loosened, the rod support 48 is free to pivot about said pivot pin 50. Said rod support 48 also contains a second adjustment screw 44 generally located near the midpoint of said recessed portion 43. Said secondary adjustment screw 44 is installed in such a manner as to produce pressure against and extension rod to be introduced into the rod support 48 recessed portion 43. Tightening the secondary adjustment screw 44 will secure an extension rod whereas loosening said screw 44 will allow the operator to remove an inserted extension rod.

Referring now to FIG. 12, the invention is illustrated as to exhibit the three major components. A base unit 10 is shown with an extension rod 12 securely positioned within and with a position indicator 14 securely located at the opposite end of said extension rod 12. The extension rod 12 is of a design and composition so as allow for the shortening of its overall length if necessary with simple tools and minimal effort or experience. A position indicator 14 is of such construction and design so as to fit tightly against the extension rod 12 when the cap portion 56 is placed over said rod 12. Placing the cap portion 56 over the extension rod 12 will form a tight waterproof seal. Furthermore, said position indicator 14 is of such a design as to be highly visible in dim light or in direct sunlight.

With reference to FIG. 13, the invention is illustrated as being able to utilize an alternative position indicator to be mounted on an extension rod 12. Said indicator is comprised of a cap portion 57 and a highly visible flag portion 58. Said flag portion 58 is of such construction and composition as to bend when contacting a moving vehicle or trailer.

Now referring to FIGS. 14 and 15, the invention is illustrated as being able to utilize an alternative position indicator 60 to be mounted on an extension rod 12. Said indicator 60 is specifically designed to be used in low light or darkness and illuminated by a vehicle back-up lights, generally located at the rear and uppermost portion of a vehicle cabin. The position indicator 60 is comprised of a cap 59 to provide a tight connection to said extension rod 12, a frame 61 and angled fins 62 of a design as to have a highly reflective face 64 and a non-reflective face 66. As an operator maneuvers a vehicle towards a trailer in low light, the vehicle back-up lights will illuminate the reflective faces 64 of said angled fins 62. The position indicator 60 will hang in a generally vertical position until it is physically contacted by an approaching vehicle. Upon contact, said vehicle will cause said frame 61 to tilt away from the contact point in a direction generally towards an existing trailer. As said frame 61 is caused to tilt, the attached angled fins 62 will tilt in such a fashion as to collectively reduce the visibility of said reflective faces 64. As a vehicle operator maneuvers the vehicle toward the position indicator 60, said indicator will eventually become very difficult to see whereas the angled fins 62 will be tilted in such a manner as to be visually unperceivable to the vehicle operator, thereby indicating a proper alignment between the trailer and vehicle.

What is claimed is:

1. An innovative improved apparatus for visually indicating a proper alignment between a trailer and vehicle wherein:
the apparatus comprises a base unit, an extension rod, a position indicator and a guidance marker;
the base unit includes a base section for the purpose of mounting to the surface of an existing trailer or vehicle, a pivotal section which is moveable in nature and may be manually locked in a desired position, and a rod support member which is designed and constructed as to contain and secure a portion of an extension rod and may be positioned and manually locked at a desired angle;
the extension rod is of a construction, design and material as to be easily reduced in length if required with simple tools and minimal effort;
the position indicator is of such design and construction as to fit tightly on said extension rod and provide a highly visible marker;
the guidance marker is of such design and construction as to be comprised of a flexible material that is highly visible or reflective about the surface and coated with an adhesive material on the opposing surface as to attach firmly to an existing vehicle or trailer.

2. Apparatus of claim 1, wherein the apparatus comprises an extension rod that is of such construction and design as to be highly flexible and resistant to breakage when subjected to a reasonable amount of compression.

3. Apparatus of claim 1, wherein the apparatus is installed on a trailer and manually configured in such a manner as to prominently display a position indicator in close proximity to a guidance marker located on the rear of a vehicle as to indicate by their relative positions a proper alignment between a vehicle hitching device and the hitching device on said trailer.

4. Apparatus of claim 1, wherein the apparatus is installed on a vehicle and manually configured in such a manner as to prominently display a position indicator in close proximity to a guidance marker located on trailer as to indicate by their relative positions a proper alignment between a vehicle hitching device and the hitching device on said trailer.

5. Apparatus of claim 1, wherein the apparatus comprises a position indicator constructed and designed in such a manner as to come in contact and bend against a vehicle or trailer as to provide a further visual indication of proper distance between a vehicle and a trailer.

6. Apparatus of claim 1, wherein the apparatus comprises a position indicator and guidance marker that are of such construction as to be highly reflective and thereby visible in low light situations or in darkness when illuminated by a vehicle's backup lights.

7. Apparatus of claim 1, wherein the apparatus comprises a position indicator constructed and designed as to be highly reflective in low light or in darkness when illuminated by vehicle back-up lights and lie generally vertical until contacted by a vehicle, upon which, said indicator will pivot and thereby reduce the reflective surface visible to the vehicle operator, thus alerting the vehicle operator of a proper distance to the trailer.

8. Apparatus of claim 1, wherein the apparatus comprises a plurality of extension rods and position indicators connected to a single base unit.

9. Apparatus of claim 1, wherein the apparatus comprises a base unit that is of a design and construction as to allow mounting to a vehicle or trailer through the use of a strapping mechanism.

10. Apparatus of claim 1, wherein the apparatus comprises a detachable base unit as to allow for the quick and easy removal of the invention from a vehicle or trailer.
